(19) United States
(12) Patent Application Publication
(10) Pub. No.: US 2007/0220184 A1
(43) Pub. Date: Sep. 20, 2007

(54) Latency-locked loop (LLL) circuit, buffer including the circuit, and method of adjusting a data rate

(75) Inventor: Jose A. Tierno, Stamford, CT (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/377,177

(22) Filed: Mar. 17, 2006

(51) Int. Cl. G06F 5/00

(52) U.S. Cl. 710/52

(57) ABSTRACT

A latency locked loop (LLL) circuit for a first in first out (FIFO) buffer, includes a latency error estimator for estimating a latency error for the buffer by measuring a latency of the buffer and comparing the measured latency to a reference latency, a loop filter for converting the latency error into a computed data rate, and a data rate generator for adjusting a rate of data at least one of into and out of the buffer such that the rate of data matches the computed data rate.

### BACKGROUND OF THE INVENTION

1. Field of the Invention

The present invention relates to a latency-locked loop (LLL) circuit for a FIFO buffer, a buffer including the circuit, and method of adjusting a data rate, and more particularly, to an LLL circuit which may allow a latency of a FIFO buffer to be reduced and/or set to a desired value.

2. Description of the Related Art

First in first out buffers, or FIFO buffers are used extensively to allow data to be transferred between two different clocks, whether they have the same frequency but unknown face relationship, or different frequency altogether. Phase and/or frequency adaptation are achieved by inserting and deleting “Idle” characters into the data stream. Information on when to insert or delete an “Idle” is extracted from the fullness of the FIFO buffer, i.e., if the FIFO buffer is nearly full, then “Idles” need to be dropped to prevent overflow; if the FIFO buffer is nearly empty, then “idles” need to be inserted to prevent underflow.

FIG. 1 illustrates a conventional FIFO buffer 100 architecture, using a circular buffer and insertion/deletion control. The conventional FIFO buffer 100 includes a circular buffer 101, read pointer 105a and write pointer 105b, comparing devices 110a, 110b which may be used to synchronize the read and write pointers respectively, high/low watermarks 120a, 120b, and Idle insertion/deletion mechanisms 140a, 140b.

In the conventional FIFO buffer 100, the read and write pointers 105a, 105b into the buffer 101 are updated every time that an item is removed or inserted into the buffer 101. To determine the number of elements in the FIFO buffer 100, the read and write pointers 105a, 105b are synchronized (re-sampled in a common clock domain), and subtracted. This number is then compared to a low and a high watermark 120a, 120b to determine whether the FIFO buffer 100 is almost empty (low watermark) or almost full (high watermark). The results of the comparison are used to control the idle insertion/deletion mechanisms 140a, 140b, and thus adapt between the two different clock rates.

This type of conventional FIFO buffer, and other similar ones, may work relatively well and reliably. Such FIFO buffers have, nevertheless, some big drawbacks, namely size and latency.

Both size and latency are a consequence of the uncertainty between the two clock frequencies. Enough storage has to be available in the FIFO buffer above the high watermark, and below the low watermark, so that there is enough time for the insertion/deletion control loop to act before the FIFO buffer underflows or overflows. The control loop can have quite a lengthy delay (double latching of asynchronous signals, computation, wait for the next available idle in the case of deletion, etc.).

Further, each clock cycle of uncertainty or delay requires an extra data register in the FIFO buffer, both above the high watermark and below the low watermark. While the low watermark is an indication of latency (in average, the number of cycles thru the FIFO buffer is higher than the low watermark), the sum of the high watermark and the low watermark is an indication of size.

### SUMMARY OF THE INVENTION

In view of the foregoing and other exemplary problems, disadvantages, and drawbacks of the aforementioned conventional systems and methods, it is a purpose of the exemplary aspects of the present invention to provide a circuit which may allow a latency of a FIFO buffer to be reduced and/or set to a desired value.

A first exemplary aspect of the present invention includes a latency locked loop (LLL) circuit for a first in first out (FIFO) buffer. The LLL circuit includes a latency error estimator for estimating a latency error for the buffer by measuring a latency of the buffer and comparing the measured latency to a reference latency, a loop filter for converting the latency error into a computed data rate, and a data rate generator for adjusting a rate of data at least one of into and out of the buffer such that the rate of data matches the computed data rate.

Another exemplary aspect of the present invention includes a first in first out (FIFO) buffer which stores (e.g., at least temporarily stores) data in a data stream. The FIFO buffer includes at least one latency locked loop (LLL) circuit, which includes a latency error estimator for estimating a latency error for the buffer by measuring a latency of the buffer and comparing the measured latency to a reference latency, a loop filter for converting the latency error into a computed data rate, and a data rate generator for adjusting a rate of data at least one of into and out of the buffer such that the rate of data matches the computed data rate.

Another exemplary aspect of the present invention includes a method of adjusting a rate of data in a data stream at least one of into and out of a first in first out (FIFO) buffer which stores the data. The method includes estimating a latency error for the buffer by measuring a latency of the buffer and comparing the measured latency to a reference latency, converting the latency error into a computed data rate, and adjusting a rate of the data in the data stream at least one of into and out of the buffer such that the rate of the data matches the computed data rate.

Another exemplary aspect of the present invention includes a programmable storage medium tangibly embodying a program of machine-readable instructions executable by a digital processing apparatus to perform a method of adjusting a rate of data in a data stream at least one of into and out of a first in first out (FIFO) buffer which stores the data.

### BRIEF DESCRIPTION OF THE DRAWINGS

The foregoing and other exemplary purposes, features, aspects and advantages will be better understood from the following detailed description of the exemplary embodiments of the invention with reference to the drawings, in which:

FIG. 1 illustrates a conventional FIFO buffer 100 architecture, using a circular buffer and insertion/deletion control;

FIG. 2 illustrates a latency locked loop (LLL) circuit 200 for a first in first out (FIFO) buffer, according to the exemplary aspects of the present invention;

FIG. 3 illustrates an exemplary FIFO buffer 300 which may include an LLL circuit (e.g., a latency-locked loop FIFO buffer with read and write latency control), according to the exemplary aspects of the present invention;

FIG. 4 illustrates a latency error estimator 410 (e.g., a latency error estimator with synchronization delay compensation) which may be a possible implementation, according to the exemplary aspects of the present invention;

FIG. 5 illustrates a loop filter 520 (e.g., a simple loop filter with proportional and integral path and output saturation), according to the exemplary aspects of the present invention;

FIG. 6 illustrates a data rate generator 630 (e.g., a data rate converter in which data with its valid bit set to “false” may be ignored), according to the exemplary aspects of the present invention;

FIG. 7 illustrates pseudocode which may be used, for example, to implement the data rate FSM 632, according to the exemplary aspects of the present invention;

FIG. 8 illustrates a method 800 of adjusting a rate of data in a data stream at least one of into and out of a first in first out (FIFO) buffer which stores the data, according to an exemplary aspect of the present invention;

FIG. 9 illustrates a typical hardware configuration which may be used for implementing the exemplary aspects of the present invention; and

FIG. 10 illustrates a programmable storage medium 1000 tangibly embodying a program of machine-readable instructions executable by a digital processing apparatus to perform a method of adjusting a rate of data in a data stream at least one of into and out of a first in first out (FIFO) buffer which stores the data, according to the exemplary aspects of the present invention.

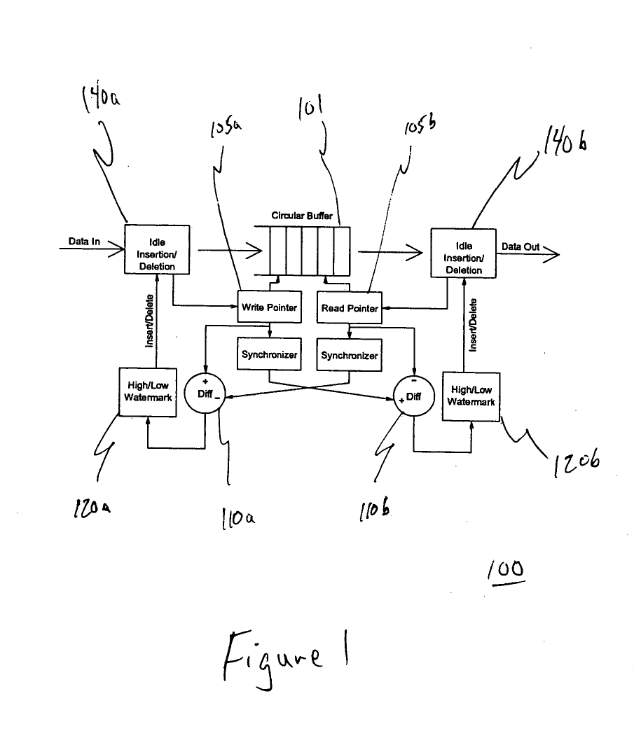

### DETAILED DESCRIPTION OF THE EXEMPLARY EMBODIMENTS OF THE INVENTION

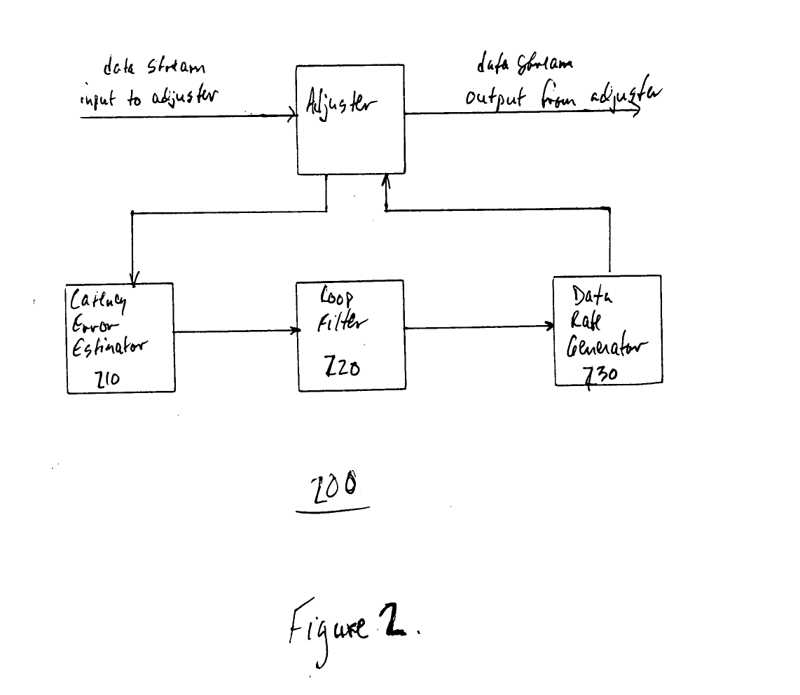

Referring now to the drawings, FIGS. 2-8 illustrate the exemplary aspects of the present invention.

Specifically, FIG. 2 illustrates a latency locked loop (LLL) circuit 200 for a first in first out (FIFO) buffer, in accordance with an exemplary aspect of the present invention. As illustrated in FIG. 2, the LLL circuit 200 may include a latency error estimator 210 for estimating a latency error for the buffer by measuring a latency of the buffer and comparing the measured latency to a reference latency, a loop filter 220 for converting the latency error into a computed data rate, and a data rate generator 230 for adjusting a rate of data at least one of into and out of the buffer such that the rate of data matches the computed data rate.

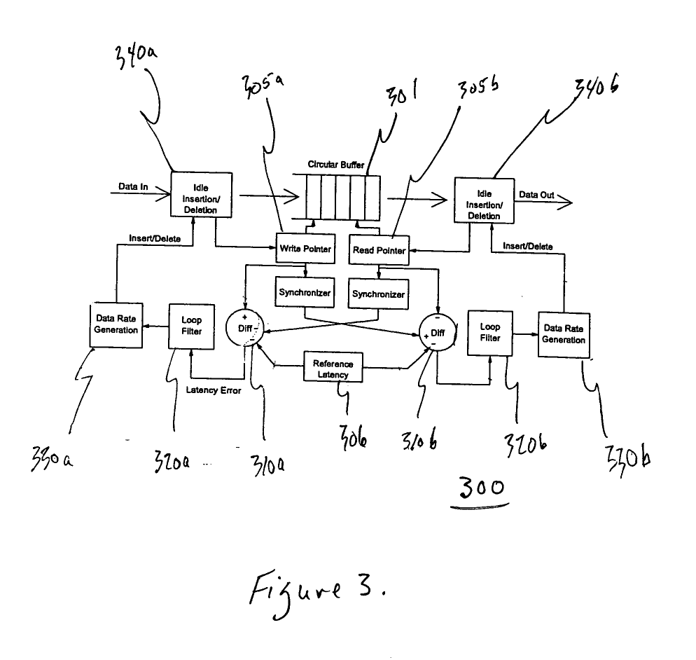

FIG. 3 illustrates an exemplary FIFO buffer 300 which may include an LLL circuit (e.g., a latency-locked loop FIFO buffer with read and write latency control) according to the exemplary aspects of the present invention. The exemplary FIFO buffer 300 includes a circular buffer 301, read pointer 305a and write pointer 305b.

The exemplary FIFO buffer 300 also includes latency error estimators 310a, 310b which may measure a latency of the buffer and compare the measured latency to a reference latency 306 (e.g., which may be stored in a memory device), loop filters 320a, 320b for converting the latency error into a computed data rate, and data rate generators 330a, 330b. The exemplary FIFO buffer 300 may also include adjusters 340a, 340b (e.g., Idle insertion/deletion mechanisms) for adjusting a rate of data in a data stream based on an output of the data rate generators 330a, 330b.

The exemplary aspects of the present invention may provide a novel manner of adjusting a data rate (e.g., using an insertion/deletion control) that may greatly reduce the size and latency of the FIFO buffer by predicting when to add and drop idles, and thus effectively cancel the effect of the long traditional control loop.

Latency Locked Loop (LLL) FIFO buffer

The Latency Locked Loop FIFO (LLLF) buffer 300, as shown in FIG. 3, is similar in concept to a phase locked loop (PLL), or a delay locked loop (DLL). The latency-locked loop consists of a latency error estimator 310, a loop filter 320 that removes some of the noise in the latency error, and a data rate generator 330, that may generate insert/delete signals to have the data rate through the FIFO buffer 300 match the rate indicated by the output of the loop filter 320. In the PLL analogy, the latency estimator 310 may correspond to the phase detector of the PLL, the loop filter 320 may correspond to the loop filter, and the data rate generator 330 may correspond to the voltage-controlled oscillator (VCO).

Latency Error Estimator

In the exemplary aspects of the present invention, the latency error estimator measures the latency through the FIFO buffer, and compares this latency to a reference. The exact implementation depends on the overall implementation of the FIFO buffer. The exemplary aspect of the present invention illustrated in FIG. 3, for example, includes a latency error estimator for a circular buffer-based FIFO buffer.

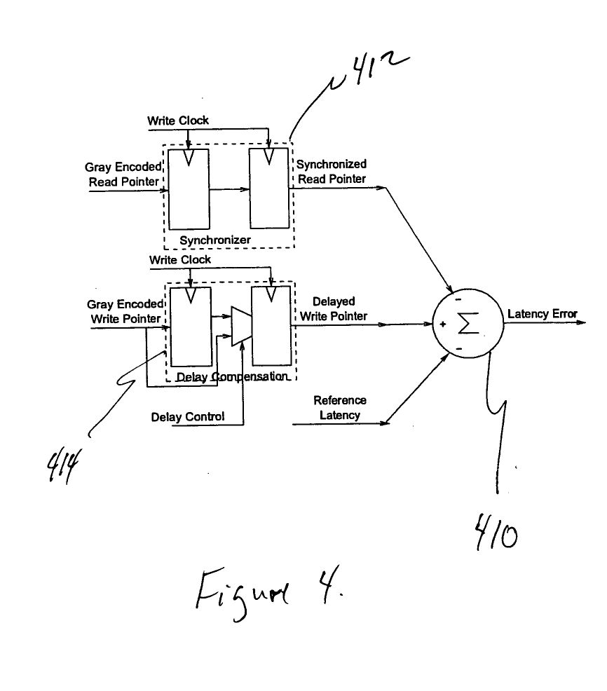

FIG. 4 illustrates a latency error estimator 410 (e.g., a latency error estimator with synchronization delay compensation) which may be a possible implementation, according to the exemplary aspects of the present invention. The latency error estimator 410 may correspond, for example, to the latency error estimator 310a illustrated in FIG. 3.

The latency error estimator 410 may include as input a synchronized read pointer, a delayed read pointer, and the reference latency. The synchronized read pointer may be generated, for example, by a synchronizer 412 having as inputs a gray encoded read pointer and a write clock signal. The delayed write pointer may be generated, for example, by a delay compensation mechanism 414 having as inputs a gray encoded write pointer, a write clock signal, and a delay control signal.

The exemplary aspects of the present of the present invention may include a circular buffer having two pointers: a write pointer that indicates where the next data item will be written, and a read pointer that indicates from where the next data item will be read. At any given point in time, the latency through the FIFO buffer corresponds to the difference between the write and read pointer, times the read clock cycle time.

Because the read and write pointers are updated in asynchronous time domains (namely the read clock and write clock), both pointers should be synchronized in a single clock domain. FIG. 4 illustrates how the read pointer, gray encoded, may be double latched into the write clock domain (e.g., for a circular buffer-based FIFO buffer).

The synchronized read pointer cannot be directly compared to the write pointer, since those two pointers represent different, points in time. The synchronization circuit may delay the read pointer anywhere from one write clock cycle to two write clock cycles, or an average of one and a half write clock cycles, when the two clocks are completely asynchronous. How to compensate for this delay may depend on how the FIFO buffer is being utilized.

FIG. 4 illustrates an example of a one and a half cycle average delay, where the delay is controlled by a pseudo random sequence. The noise introduced by this device may be removed by the loop filter, but the synchronization delay may be compensated for exactly.

The synchronized read pointer and delayed write pointer can, therefore, be subtracted and compared to the reference latency in the latency error estimator, to generate the latency error. Notice that fractional values can be used for the reference latency (i.e., the reference latency does not need to be rounded up to the next integer value, since this reference is a representation of time and not clock cycles).

Loop Filter

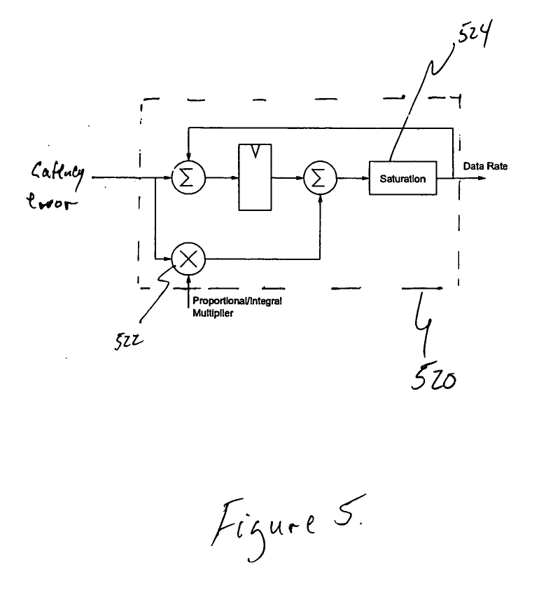

FIG. 5 illustrates a loop filter 520 (e.g., a simple loop filter with proportional and integral path and output saturation), according to the exemplary aspects of the present invention. A purpose of the loop filter is to convert the latency error (e.g., generated by the latency error estimator) into a data rate. The data rate of the FIFO buffer is the average number of items that are written into (write data rate) or read from (read data rate) the FIFO buffer in one clock cycle. In a steady state, the number of items written into the FIFO buffer per unit time may be the same as the number of items read from the FIFO buffer per unit time. That is:
R_{w}×f_{w}=Rᵣ×fᵣ (1)
where R_{w} is the write data rate, f_{w} is the write frequency, Rᵣ, is the read data rate, and fᵣ, is the read frequency.

For example, as illustrated in FIG. 5, the loop filter 520 may include a mechanism 522 for multiplying the latency error signal by a proportional/integral multiplier, and a saturation mechanism 524. Thus, for example, the loop filter (e.g., in a simple form) may include a digital filter, with a proportional path for rapid convergence, and an integral path for zero latency error steady state condition. In this case, it may be necessary to saturate the digital filter at zero and one. However, more elaborate filters can be considered for specific problems, since the error signal has a colored spectrum.

Data Rate Generator

In the exemplary aspects of the present invention, a data rate generator (e.g., data rate generator 230) may be used to adjust a rate of data in a data stream at least one of into and out of the FIFO buffer such that the rate of the data matches a computed data rate (e.g., a data rate computed by the loop filter).

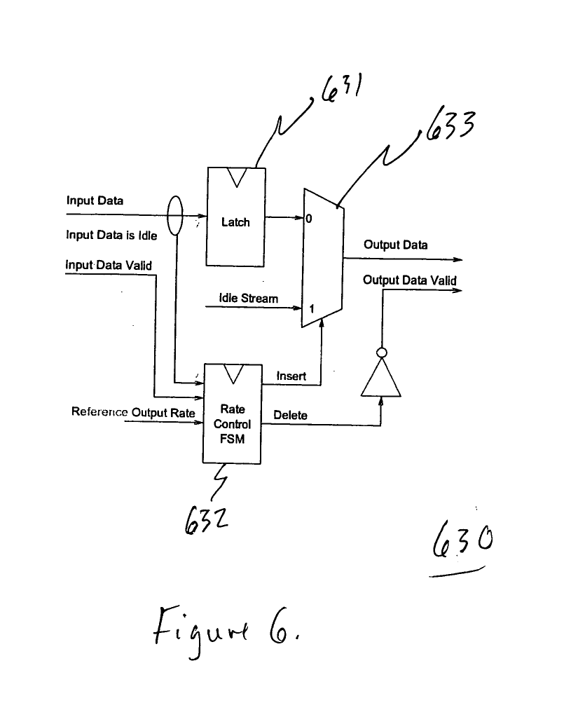

FIG. 6 illustrates a data rate generator 630 (e.g., a data rate converter in which data with its valid bit set to “false” may be ignored), according to an exemplary aspect of the present invention. As illustrated in FIG. 6, the data rate generator 630 may use the output of the loop filter (e.g., loop filter 320) to control the insertion and/or deletion (e.g., insertion/deletion) of Idle characters, so that the data rate into (or out of) the FIFO buffer matches the data rate computed by the loop filter.

The data rate generator 630 may include, for example, a latch 631 which receives input data, and a finite state machine (FSM) 632 (e.g., a rate control FSM) which receives input data and a reference output data rate (e.g., from the loop filter). The data rate generator 630 may also include a multiplexer 633 which multiplexes a signal output from the latch, an idle stream signal, and an insert signal from the FSM 632, to generate the output data.

The “data rate” may be defined as the number of items written into (or read from) the FIFO buffer per clock cycle. If the FIFO buffer has a single write (read) port, then the write (read) data rate is less than or equal to one. The data producer (e.g., a device which generates a data stream to be input to the FIFO buffer) may send to the FIFO buffer a mix of data items and idle characters. Idle characters may contain some sideband information, but a main purpose of the Idle characters is to allow the FIFO buffer to balance the producer/consumer rates so that they are in balance, as established by Equation (1) above. The data rate may be reduced by dropping idles, and increased by inserting idles.

For example, in the data rate generator 630 illustrated in FIG. 6, the input and output data can be either “valid data,” “valid idle,” or “invalid.” Invalid items, marked by an invalid bit, represent clock cycles where data is not available. Invalid data is never written or read from the FIFO buffer, and thus represents a basic mechanism of rate control.

The rate control finite state machine (FSM) 632 may look at the type of the input data, and set the type of the output data according to the following conversion rules:
Valid Idle may be converted to Invalid, to reduce the output data rate,
Invalid may be converted to Valid Idle, to increase the output data rate, and
Valid Data is never converted.

A purpose of the state machine (FSM) is to apply the above rules to obtain an output data rate that asymptotically matches the reference output rate (e.g., from the loop circuit).

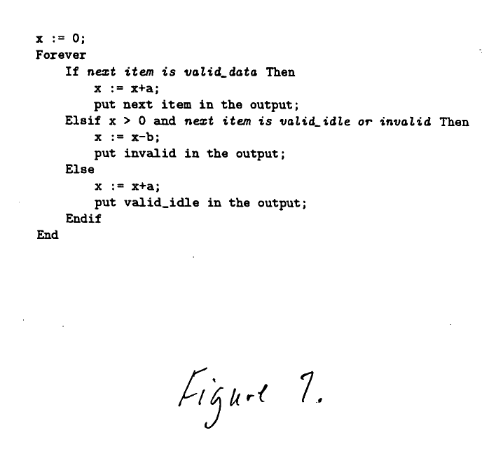

The pseudocode in FIG. 7 (e.g., data rate FSM pseudocode) may be used, for example, to implement the data rate FSM 632. In this pseudocode, a and b may include two positive integer constants, and x may include an integer variable.

It should be noted that every time that a valid item is put in the output, x may be increased by the amount of a, and every time that invalid data is put in the output, x may be decreased by the amount of b. Thus, letting N be the total number of items, Vi the number of valid items in the input, Dn, the number of valid data items in the input, and Vo the number of valid items in the output, the output data rate Ro may be defined by:
Rₒ=Vₒ/N
and the following loop invariant may be obtained:
   Vₒ·a−(N−Vₒ)·b=x
   or
   Vₒ/N=b/(a+b)+x/N (2)

It can be shown that if Dₙ/N<b/(a+b) then x remains bounded, and unbounded otherwise. Thus, for very large N, the loop invariant may be given as follows:
b/(a+b), if Dₙ/N<b/(a+b)
Vₒ/N≈ (3)
Dₙ/N, otherwise.

An idea behind this algorithm is to use the constant b (and/or the constant a) input into the FSM as analogous to the input voltage for the VCO in a PLL, with the output data rate being analogous of the output frequency of the PLL. There may be a maximum achievable data rate (e.g., 1.0 for a single output), and a minimum achievable data rate where only the valid data items are allowed to go through.

In summary, the present invention may allow a digital circuit to bridge asynchronous clock boundaries. While there may be many solutions to the problem using asynchronous FIFOs (e.g., FIFO buffers), the present invention may be optimized for low latency, by using a latency-locked loop to actually measure the latency between clock domains, and thus set the latency to a minimum compatible with a safe operation.

The present invention may include a control mechanism for an asynchronous FIFO buffer. The invention may include a data rate generator, a latency error estimator and a loop filter. Several configurations may be possible, depending upon the specific details of the read and write clock into the buffer. Latency may be measured and compared to a reference latency in a latency-locked loop, and can thus be set to any arbitrary value, as opposed to a conventional FIFO buffer, in which latency may be a bit of an unknown. In addition, a solution of the present invention may be very efficient in plesiochronous mode (e.g., as efficient as a purely plesiochronous implementation), and can thus be used in an asynchronous/plesiochronous configurable environment.

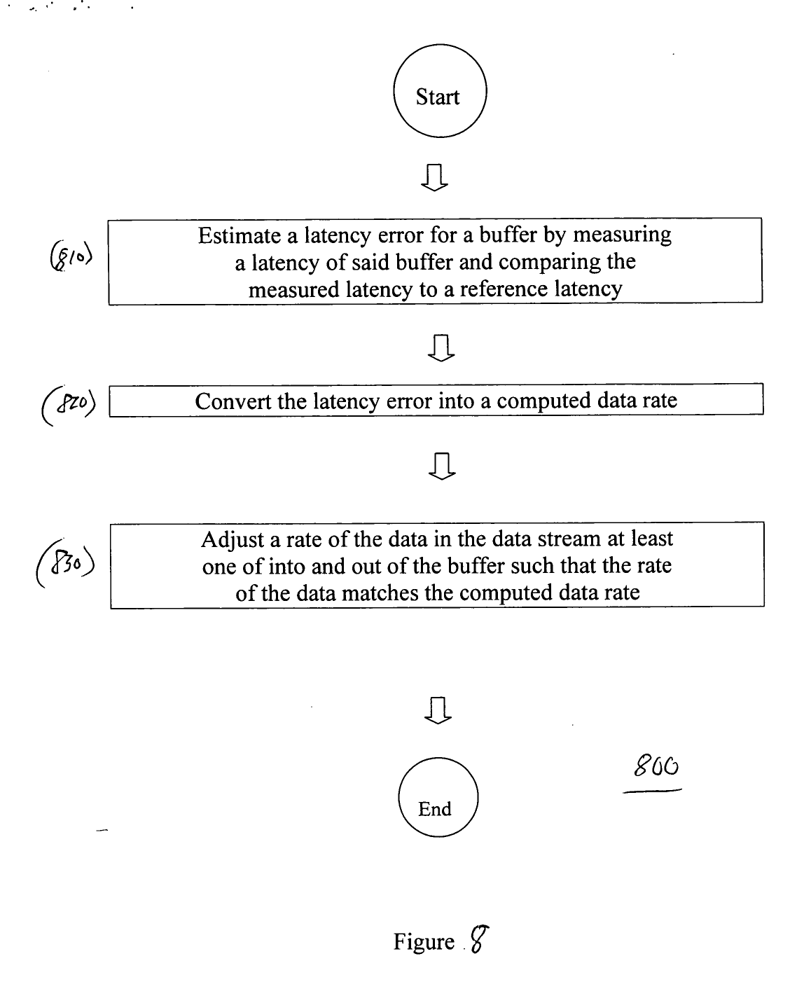

FIG. 8 illustrates a method 800 of adjusting a rate of data in a data stream at least one of into and out of a first in first out (FIFO) buffer which stores said data, according to an exemplary aspect of the present invention. The method 800 may include estimating (810) a latency error for the buffer by measuring a latency of the buffer and comparing the measured latency to a reference latency, converting (820) the latency error into a computed data rate, and adjusting (830) a rate of the data in the data stream at least one of into and out of the buffer such that the rate of the data matches the computed data rate. The method 800 may be implemented, for example, using a device similar to that described above with respect to the LLL circuit 200 or the FIFO buffer 300, and therefore the discussion above may be equally applicable in describing the method 800. Further, at least a portion of the method 800 may be software implemented. That is, at least a portion of the method 800 may be performed by using a digital processing apparatus to execute a program of machine-readable instructions tangibly embodied on a programmable storage medium.

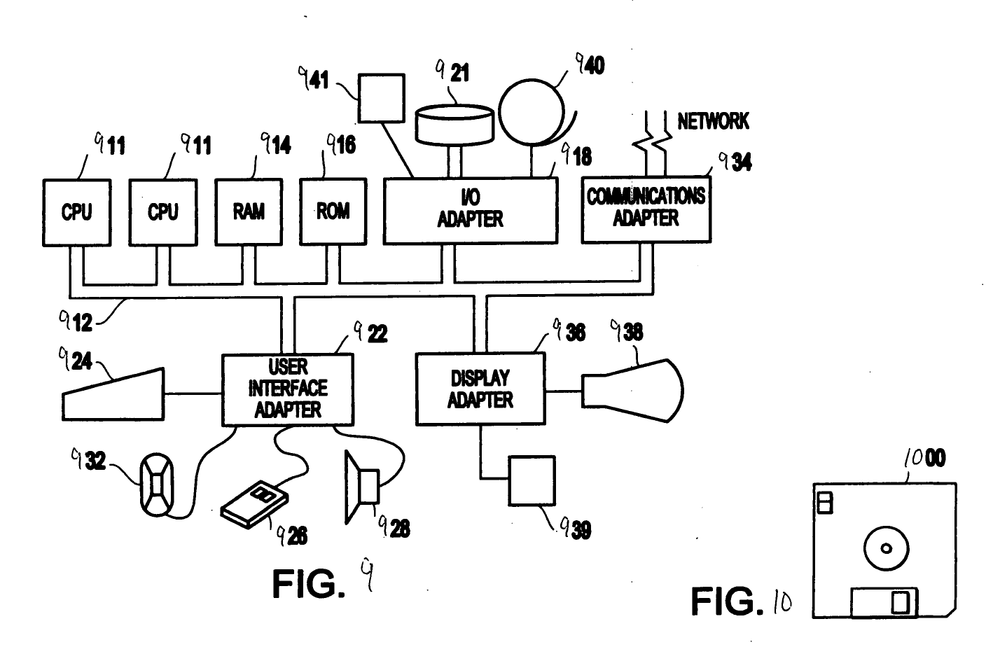

Referring again to the drawings, FIG. 9 illustrates a typical hardware configuration which may be used for implementing the exemplary aspects of the present invention. The configuration has preferably at least one processor or central processing unit (CPU) 911. The CPUs 911 are interconnected via a system bus 912 to a random access memory (RAM) 914, read-only memory (ROM) 916, input/output (I/O) adapter 918 (for connecting peripheral devices such as disk units 921 and tape drives 940 to the bus 912), user interface adapter 922 (for connecting a keyboard 924, mouse 926, speaker 928, microphone 932, and/or other user interface device to the bus 912), a communication adapter 934 for connecting an information handling system to a data processing network, the Internet, and Intranet, a personal area network (PAN), etc., and a display adapter 936 for connecting the bus 912 to a display device 938 and/or printer 939. Further, an automated reader/scanner 941 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including signal-bearing media tangibly embodying a program of machine-readable instructions executable by a digital data processor to perform the above method.

Such a method may be implemented, for example, by operating the CPU 911 to execute a sequence of machine-readable instructions. These instructions may reside in various types of signal bearing media.

Thus, this aspect of the present invention is directed to a programmed product, including signal-bearing media tangibly embodying a program of machine-readable instructions executable by a digital data processor incorporating the CPU 911 and hardware above, to perform the method of the invention.

This signal-bearing media may include, for example, a RAM contained within the CPU 911, as represented by the fast-access storage for example. Alternatively, the instructions may be contained in another signal-bearing media, such as a magnetic data storage diskette 1000 (FIG. 10), directly or indirectly accessible by the CPU 911.

Whether contained in the computer server/CPU 911, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, complied from a language such as “C” etc.

The unique and novel features of the present invention allow the present invention to provide a circuit which may allow a latency of a FIFO buffer to be reduced and/or set to a desired value.

While the invention has been described in terms of one or more exemplary embodiments, those skilled in the art will recognize that the invention can be practiced with modification within the spirit and scope of the appended claims. Specifically, one of ordinary skill in the art will understand that the drawings and the discussion of the exemplary aspects herein are meant to be illustrative, and the design of the inventive assembly is not necessarily limited to that disclosed herein but may be modified within the spirit and scope of the present invention.

Further, Applicant's intent is to encompass the equivalents of all claim elements, and no amendment to any claim the present application should be construed as a disclaimer of any interest in or right to an equivalent of any element or feature of the amended claim.

1. A latency locked loop (LLL) circuit for a first in first out (FIFO) buffer which stores data in a data stream, comprising:
a latency error estimator for estimating a latency error for said buffer by measuring a latency of said buffer and comparing said measured latency to a reference latency;
a loop filter for converting said latency error into a computed data rate; and
a data rate generator for adjusting a rate of said data in said data stream at least one of into and out of said buffer such that said rate of said data matches said computed data rate.

2. The LLL circuit of claim 1, further comprising:
an adjuster which adjusts said rate of said data in said data stream based on an output of said data rate generator.

3. The LLL circuit of claim 2, wherein said data rate generator comprises a data rate converter which uses an output of said loop filter to control at least one of an insertion and deletion of idle characters in said data stream.

4. The LLL circuit of claim 3, wherein said data rate converter reduces a rate of data in said data stream by dropping idle characters in said data stream, and increases said rate of data in said data stream by inserting idle characters in said data stream.

5. The LLL circuit of claim 3, wherein data in said data stream which is input to and output from said data rate converter, comprises one of “valid data,” “valid idle,” and “an invalid bit” which represents clock cycles where data is not available.

6. The LLL circuit of claim 3, wherein said data rate converter comprises a rate control finite state machine (FSM) which considers a type of data input to said data rate converter, and sets a type of data which is output from said data rate converter according to the following conversion rules:
Valid Idle may be converted to Invalid, to reduce the output data rate;
Invalid may be converted to Valid Idle, to increase the output data rate; and
Valid Data is never converted.

7. The LLL circuit of claim 6, wherein said finite state machine (FSM) applies said rules to obtain an output data rate that asymptotically matches a reference output data rate.

8. The LLL circuit of claim 7, wherein said FSM is implemented using pseudocode in which a loop invariant Vₒ/N is given by:
b/(a+b), if Dₙ/N<b/(a+b)
Vₒ/N≈ (3)
Dₙ/N, otherwise.
wherein a and b are positive integer constants, x is an integer variable, N in the total number of items in the data stream input to said data rate converter, Vᵢ the number of valid items in the data stream input to said data rate converter, Dₙ is the number of valid data items in the data stream input to said data rate converter, and Vₒ the number of valid items in the data stream output from said data rate converter.

9. The LLL circuit of claim 8, wherein a data rate of said data stream output from said data rate converter is controlled by inputting at least one of a and b into said FSM.

10. The LLL circuit of claim 1, wherein said FIFO buffer comprises a circular buffer which uses a read pointer and a write pointer to control reading data from said circular buffer and writing data to said circular buffer, respectively.

11. The LLL circuit of claim 10, wherein said read pointer comprises a synchronized read pointer and said write pointer comprises a delayed write pointer.

12. The LLL circuit of claim 11, wherein said latency error estimator measures said latency by determining a difference between said synchronized read pointer and said delayed write pointer.

13. The LLL circuit of claim 1, wherein said loop filter comprises a digital filter having a proportional path for rapid convergence, and an integral path for a zero latency error steady state condition.

14. The LLL circuit of claim 13, wherein said loop filter is saturated for a latency error equal to zero and one.

15. The LLL circuit of claim 1, wherein said latency of said buffer is set to an arbitrary value.

16. The LLL circuit of claim 1, wherein said latency of said buffer is set to a minimum compatible with a safe operation of said buffer.

17. A first in first out (FIFO) buffer which stores data in a data stream, comprising:
at least one latency locked loop (LLL) circuit, comprising:
a latency error estimator for estimating a latency error for said buffer by measuring a latency of said buffer and comparing said measured latency to a reference latency;
a loop filter for converting said latency error into a computed data rate; and
a data rate generator for adjusting a rate of said data in said data stream at least one of into and out of said buffer such that said rate of said data matches said computed data rate.

18. The FIFO buffer of claim 17, further comprising:
a write pointer for indicating where a next data item will be written in said buffer; and
a read pointer, for indicating from where in said buffer that a next data item will be read.

19. A method of adjusting a rate of data in a data stream at least one of into and out of a first in first out (FIFO) buffer which stores said data, comprising:
estimating a latency error for said buffer by measuring a latency of said buffer and comparing said measured latency to a reference latency;
converting said latency error into a computed data rate; and
adjusting a rate of said data in said data stream at least one of into and out of said buffer such that said rate of said data matches said computed data rate.

20. A programmable storage medium tangibly embodying a program of machine-readable instructions executable by a digital processing apparatus to perform the method of claim 19.
